(19) United States
(12) Patent Application Publication
(10) Pub. No.: US 2019/0026830 A1
(43) Pub. Date: Jan. 24, 2019

(54) Investment Tool

(71) Applicant: Sheldon Orlando POWELL, Port of Spain (TT)

(72) Inventor: Sheldon Orlando POWELL, Port of Spain (TT)

(21) Appl. No.: 16/042,788

(22) Filed: Jul. 23, 2018

Related U.S. Application Data
(60) Provisional application No. 62/535,690, filed on Jul. 21, 2017.

(51) Int. Cl. G06Q 40/04; G06F 3/0485; G06F 3/0484; G06Q 40/06

(52) U.S. Cl. CPC G06Q 40/04; G06Q 40/06; G06F 3/04842; G06F 3/0485

(57) ABSTRACT

Certain example embodiments described herein relate to techniques for training users in investment instrument trading. Example implementations of a trading/training tool provide for displaying a configurable number of top stocks or other investment instruments in which one or more investment authorities have invested in, the sectors they have invest in and the amount of money invested in each, the portion of portfolio exposure and market value, and price in real time so users can substantially replicate their strategy with fractional shares that allows them to invest in smaller amounts but own the same or similar mix of investment using similar methodologies employed by the investing authorities from a click of a button in a mobile application with virtual and/or real money. The mobile application includes support for what is described in the application as “seamless investing”.

### CROSS REFERENCE TO RELATED APPLICATIONS

This application claims priority to U.S. Provisional Application No. 62/535,690 filed Jul. 21, 2017, the entire content of which is hereby incorporated by reference.

### TECHNICAL FIELD

Certain example embodiments described herein relate to tools for investing in securities and the like.

### BACKGROUND

Trading in securities, such as, financial securities instruments like stocks, bonds, mutual funds, etc., can be financially risky. It is desirable that the users who engage in trading activity “know” the market in which they trade such securities. That is, it is generally thought (although often not necessarily true) that knowledge of current information associated with each of the companies, mutual funds, etc. whose stock and/or other investment instruments one intends to trade in, is beneficial. However, the typical casual investor does not have such knowledge regarding a range of investment instruments. This typically results in users spending substantial time researching the subjects of the technology/product areas and or the companies/funds associated with the stocks or other financial instruments in which they intend to trade.

Additionally, many potential users have little or no familiarity with electronic trading of such financial instruments. It is desirable that, before engaging in trading financial instruments using actual money, that users would be able to develop some familiarity with how trades are carried out, how the news or other factors affect the current value of a financial instrument, etc.

The continuing growth and pervasiveness of the Internet and also the continued improvements in financial securities trading platforms, make it even more important for users to have gained some familiarity and training in trading on electronic trading platforms (e.g., Internet-accessible trading platforms provided by brokerages, etc.) while making use of the best information and analysis in a timely manner.

Financial trading applications which allow users to engage in financial trading are conventionally known. The existing tools enable a user to specify the type and quantity of a financial instrument that he/she wants to sell/buy, and enable users to access news and/or research associated with various financial instruments.

However, it is desired that improved tools for providing training to get users more familiar in the art of trading in financial securities, in how trading is executed, in how to access research and/or news regarding financial instruments, and/or in how to monitor and maintain a portfolio over time are available.

### SUMMARY OF EXAMPLE EMBODIMENTS OF THE INVENTION

Certain example embodiments described herein relate to tools, techniques and/or user interfaces for trading and/or training trading in securities, such as, financial securities.

Certain example embodiments described herein relate to techniques for training users in investment instrument trading. Example implementations of a investing tool (also referred to herein as a trading/training tool) provide for displaying a configurable number of top stocks or other investment instruments in which one or more investment authorities have invested in, the sectors they have invest in and the amount of money invested in each, the portion of portfolio exposure and market value, and price in real time so users can substantially replicate their strategy with fractional shares that allows them to invest in smaller amounts but own the same or similar mix of investment using similar methodologies employed by the investing authorities from a click of a button in a mobile application with virtual and/or real money.

These aspects, features, and example embodiments may be used separately and/or applied in various combinations to achieve yet further embodiments of this invention.

### BRIEF DESCRIPTION OF THE DRAWINGS

These and other features and advantages may be better and more completely understood by reference to the following detailed description of exemplary illustrative embodiments in conjunction with the drawings, of which:

FIG. 1 illustrates a system environment including a trading/training tool, in accordance with certain example embodiments;

FIG. 2 is a block diagram illustrating some functional modules of the trading/training tool shown in FIG. 1, according to some example embodiments;

FIG. 3 illustrates a user interface (UI) rendered on a client device when a user logs in, in accordance with some example embodiments;

FIG. 4 illustrates a UI that provides the logged in user with an overview of the user's portfolio and/or a drill-down into a selected investing authority, in accordance with some example embodiments;

FIG. 5 illustrates a UI showing selected investing authorities, in accordance with certain example embodiments;

FIG. 6 illustrates a UI showing a selected investing authority's information, in accordance with certain example embodiments;

FIG. 7 illustrates a UI for enabling the logged in user to compare investment authorities, in accordance with certain example embodiments;

FIG. 8 illustrates a displayed output of an investment authority comparison, in accordance with certain example embodiments;

FIG. 9 illustrates a displayed output showing trading insights, in accordance with certain example embodiments;

FIG. 10 illustrates aspects of a feature that enables a user to emulate or substantially replicate an investment authority's investment portfolio in real time via click of a button, in accordance with certain example embodiments;

FIG. 11-14 illustrate a process for performing trading training and/or trading using an application such as the trading training application shown in FIG. 1, in accordance with certain example embodiments;

FIG. 15 illustrates a trigger framework for use in the trading/training application according to some embodiments; and

FIG. 16 illustrates a computing device which may be used to implement elements shown in FIG. 1, in accordance with certain example embodiments;

### DETAILED DESCRIPTION OF EXAMPLE EMBODIMENTS

Example embodiments of the present invention provide for training tools, techniques and/or user interfaces for engaging in trading of securities, such as, financial instruments. Example financial instruments include, but are not limited to, stocks, bonds, options, initial public offerings (IPO), foreign currency (Forex), employee trust funds (ETF), mutual funds, etc. The inventor has discovered techniques by which the large amounts of digitally stored financial instrument related information that is available on the web (e.g., World Wide Web) can be utilized in order to provide tools and techniques to enable even users who have little or no investing knowledge to make informed choices in selecting investments that are more likely to yield benefits.

According to some example embodiments, a tool enables a user to efficiently identify one or more entities (referred to herein as “investing authorities”) that are recognized as successful investors, and to efficiently structure his/her own portfolio in manners similar to those entities. The tools enable the user to benefit from the researching performed by those entities while also enabling the user to more quickly engage in trading a particular group of financial instruments than would have been possible with conventional tools. Some example embodiments enable a user to identify, as selected investing authorities, one or more wealthy individuals (e.g., known billionaires), asset managers, pension funds etc., and to emulate the choices of those identified investing authorities in the user's own portfolio, and thereby trade in investments more efficiently and effectively. Some example embodiments, may enable the user to replicate respective portions of his portfolio in manners similar to each of a plurality of wealthy individuals, asset managers, pension funds etc. In some example embodiments, the tool also provides for trading in actual money on a public or private electronic trading platform (e.g., electronic trading platform provided by a brokerage).

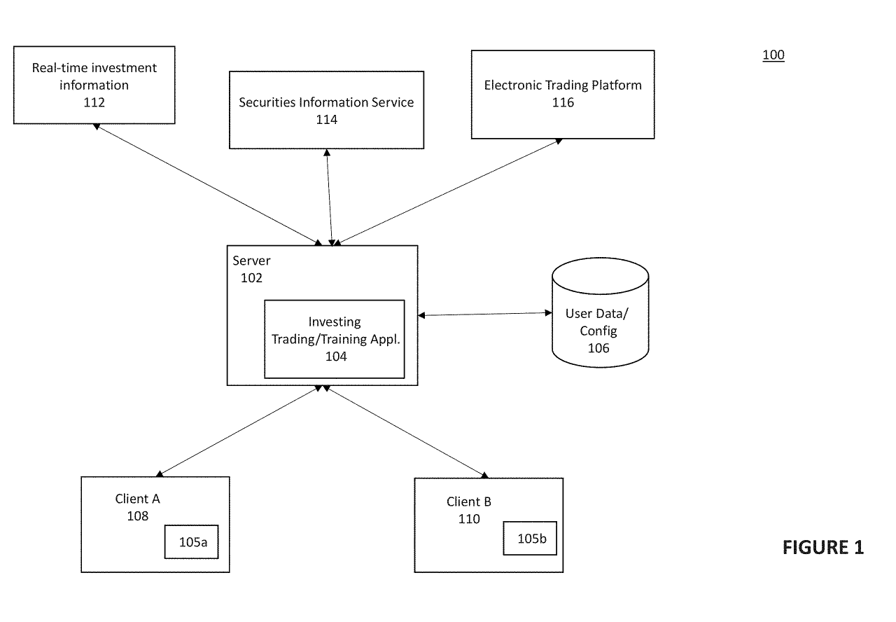

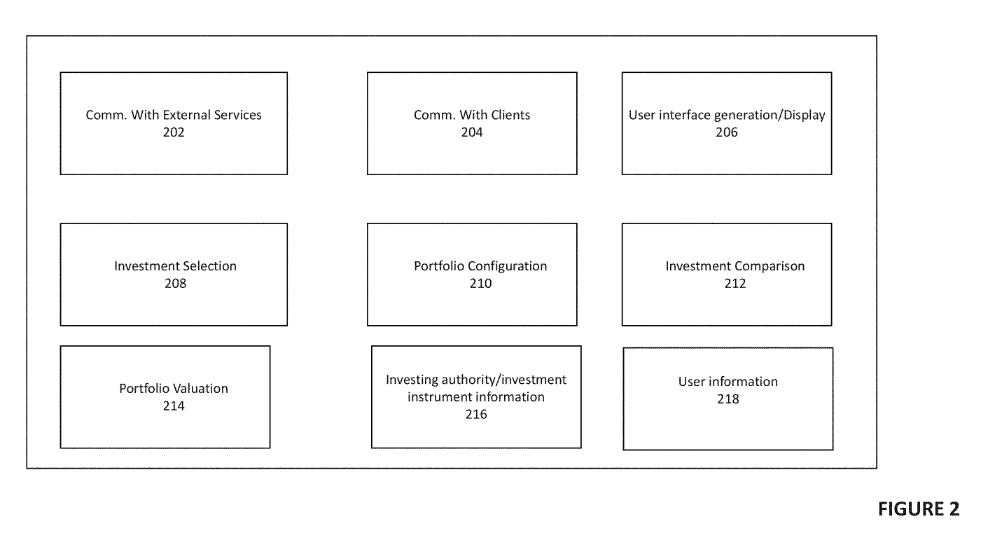

FIG. 1 illustrates a system environment 100 including a trading/training tool (also referred to as the “trading training application”) 104 in accordance with some example embodiments. The trading/training tool 104, which is described in more detail below in relation to FIGS. 2-13, may execute as an application in a server 102. Server 102 may include one or more of a web server and/or application server, and may include one or more computers communicatively connected over a network such as a local area network or a wide area network such as, for example, the Internet. In example embodiments, the server 102 and/or trading/training tool 104 may be distributed over multiple computers/processors in a cloud service provider network. The trading/training tool 104 may have access to one or more data storages 106. Data storage 106 may include one or more digital memory devices at one or more geographic locations, communicatively connected to the server 102. Data storage 106 may provide storage for some or all of the data (e.g., application code, user data, investment data, configuration information, etc.), and may include one or more databases or other data structures organizing the data.

Each client device 108 and 110 may execute a client-side portion 105 (shown as 105a on client 108 and 105b on client 110) of the investment trading tool 104. The client-side portion 105 provides a user with an interface with which to access and/or interact with the trading/training tool 104. The client-side portion of the tool may be run within a web browser and/or as a native app which accesses the trading/training tool 104 on the server 102. Client devices 108 and 110 may include any type of computing device such as, but are not limited to, PCs, laptop or notebook computers, tablet computers, smartphones, smartwatches, and the like. The communication between server 102 and clients 108/110 may be HTTP-based.

Each of the external servers 112, 114 and 116 provide data and/or data analysis to the trading/training tool 104, and/or may provide a trading platform with which the trading/training tool 104 interacts. External server 112, for example, may provide real-time stock price information. The communication between external server 112 and server 102 may be based upon HTTP/JSON. According to some example embodiments, external server 112 may include an electronic trading platform such as that provided by a broker/dealer. Server 102 and/or trading training application 104 may interact with the external server 112 by calling a published application programming interface (API), such as, for example, an API published by broker/dealer to enable other services to access the broker/dealer platform. Server 102 and/or trading training application 104 may interact with external server 112 in order to obtain real-time valuations of stocks or other investments. For example, real-time stock price quotes may be obtained via an API by providing the external server 112 with one or more ticker symbols. The returned information may include, for each input ticker symbol, the current stock price, trading volume, and some (e.g., per configuration or input parameter) historical price and/or volume information.

External server 114 may, for example, provide data regarding particular investment instruments, entities and/or individuals to the trading training application 104. According to some example embodiments, external server 114 may include a data service such as financial information service which is a subscription service for investment and investment-related information. Trading training application 104 may access data from external server 114 by using an API provided by the external server 114.

According to some embodiments, external server 114 may include an analytics (e.g., big data analytics and/or artificial intelligence-enabled analytics) service. For example, in some embodiments the external server 114 may include IBM Watson™ service to which the trading application 104 may provide user data and/or user investment information etc. on backend to obtain recommendations and/or advice (e.g., as from a financial advisor) and goal based investing suggestions to help users achieve a particular target. User profiles (user information selectively filtered for obtaining relevant analytics) for submission to the analytics service may be automatically generated based on current user portfolio status. Users may configure one or more personal targets to which the advice may be generated on an ongoing basis as the user's portfolio continues to evolve either through user-initiated actions, or through market changes. In addition, in certain embodiments, the analytics service on external server 114 may also aggregate transaction information of the billionaires, investment banks and pension fund portfolios which enable users to create, customize and/or activate predictive model goal setting by comparing billionaires amongst each other at a given time period which the analytics service will forecast as top performer in the future based on stock price, new transaction, closed transaction, increased transaction, reduced transaction and sector exposure comprised from their top 11 stock portfolio holdings.

External server 116 may include an electronic trading platform, such as, for example, an internet-accessible trading platform provided by a brokerage. In some example embodiments, trading training application 104 may interact with the electronic trading platform on external server 116 in order to execute trades for a user who is interacting with trading/training tool 104 via a client-side portion 105 on a client device. The user may, for example, in addition to being registered with the trading/training tool 104, be also registered and have an account with the electronic trading platform on external server 116. The user may, via the trading/training tool 104, trade stocks or other investment instruments on the electronic trading platform on external server 116. For example, the user may evaluate various stock purchase options and the like using the trading/training tool 104, which obtains the necessary information from external servers 112-116 during user interaction, and thereafter, choose to have a selection of stocks picked on the trading/training tool 104 transmitted to the external server 116 to be transacted on an actual market using an account for that user.

The interaction between trading/training tool 104 and any of the external servers 112-116 may be synchronous or asynchronous. For example, the obtaining of stock price information for one or more specified stock symbols may be performed synchronously using an API provided by external server 112. In some example embodiments, the API may also provide for the trading training application 104 to register one or more callbacks that can be called by external server 112 upon occurrence of events, such as, for example, a sharp (e.g., exceeding a configured threshold) increase or decrease in the price of a specified stock or other investment instrument. Communication between data service 114 and server 102 may be based upon HTTP/JSON, but is not limited thereto.

FIG. 2 is a block diagram illustrating various functional modules of investment training tool 104 shown in FIG. 1, in accordance with some example embodiments.

Modules 202-218 may include software and instruction logic for performing certain communication tasks, user interface generation and display tasks, algorithms for selecting investing authorities and/or investment instruments, and for performing evaluations etc., in the processing of trading training application 104. One or more of the modules 204-214 may include portions of software or logic for execution on the server 102 and portions for execution on a client such as client devices 108-110.

Module 202 may operate to provide communication with external servers/services, such as, for example, external servers 112-116. The communication may include HTTP/JSON message exchanges and/or other communication protocols. In some example embodiments, the communication may be in accordance with an API published by the external server for public or subscription use, and may support one or both of synchronous modes of communication or asynchronous modes of communication. Module 202 may operate to maintain one or more sessions with any of the externals servers 112-116 during a session of a user logged in to the trading/training tool. For example, when user A is logged in to the trading/training tool, sessions may be established with one or more of the external servers 112-116 to service the requests of user A. Establishing each session may include obtaining a token from an external server of concern, such that the token can be passed with each subsequent request to that external server.

Module 204 may operate to provide communication with client devices. The communication may include HTTP/JSON message exchanges and/or other communication protocols. In some example embodiments, the communication may support one or both of synchronous modes of communication or asynchronous modes of communication. Embodiments may employ techniques to increase throttle speed for data traffic to flow from 2 to 5000 speed, e.g., 2 calls per second and 5000 calls per day.

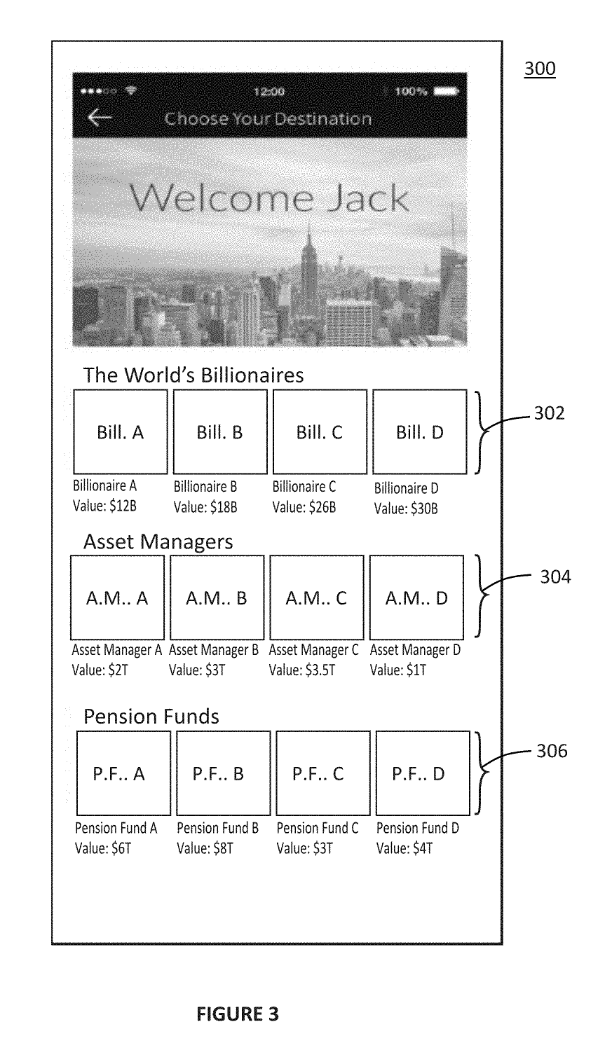

Module 206 may operate to generate and display user interfaces. The user interfaces may be displayed on, for example, client devices 108 or 110 by client-side portions 105. Example user interfaces are shown in FIGS. 3-10.

Module 208 may operate to provide for the selection of investing authorities and/or investment instruments. Module 208 may include selection of billionaires, pension funds etc. to be presented as potentially selectable investing authorities to a logged in user. Module 208 may also provide for selection of individual investments and/or combinations of individual investments for a logged in user. As described below, the automatic selection of investing authorities and/or investment instruments for subsequent user selection may include collecting and analyzing information regarding investing authorities and/or investment instruments, filtering investing authorities and/or investment instruments in accordance with a user's configurations and/or current portfolio content and/or performance etc. Based on collected information, module 208 may construct representative portfolios for each investing authority. A particular investing authority's “representative portfolio” includes information regarding investments known to the trading/training tool (e.g., by accessing external servers 112-116) as being owned by that particular investing authority. The collected information and the constructed representative portfolios may be stored in data storage 106, so that they can be accessed as appropriate for multiple logged in users of the trading/training tool.

Module 210 may operate to provide for configuring a logged in user's portfolio. For example, module 210 provides for the user to reconfigure the investments in his/her portfolio in accordance with the selected investing authorities by executing one or more trades (using the user's virtual money in the trading/training tool or, at least in some embodiments, on a broker-provided trading platform using real money) that substantially replicates the selected investing authority's investing actions and/or portfolio.

Module 212 may provide for comparing two or more investments selected by the logged in user. The investments selected for comparing may be individual investments (e.g., individual stocks etc.) or may be investing authorities (e.g., billionaires, asset managers and/or funds).

Module 214 may provide for continually evaluating the logged in user's portfolio taking into account the user-initiated changes and market changes. Module 214 may also provide for saving the logged-in user's portfolio for future access.

Modules 216-218 provide for storing and accessing information. Module 216 provides for storing and accessing information regarding the investing authorities and their representative portfolios. The stored information may also include information regarding financial instruments.

Module 218 provide for storing and accessing information regarding the users of the trading/training tool. The stored information may include user identifying information, user preference information, user configurations (e.g., configurations specifically elected by the user and configurations dynamically determined based upon user's historical actions using the trading/training tool), and user portfolio information.

FIG. 3 illustrates a user interface (UI) 300 that may be rendered on the client device when a user logs in, in accordance with some example embodiments. For example, UI 300 may be rendered on client device 108 by client-side portion 105a of the trading/training tool 104, when a user logs into the trading/training tool. The UI 300 may include an area where a welcome message is displayed and another area where one or more scrollable lists with user selectable choices of investing authorities are displayed. The scrollable lists 302, 304 and 306 provide a plurality of billionaires, a plurality of asset managers, and a plurality of pension funds, respectively, from which the user may select his/her investment choices. The billionaires, asset managers and/or pension funds may be custom selected for the logged in user based upon user configurations and/or historical performance of the user and/or the investment option. For example, for a particular user who is configured (e.g., due to user-selected configuration or due to subscription plan to the trading/training tool 104) to select from billionaires and pension funds, but not asset managers, as investing authorities, only scrollable lists 302 and 306 may be displayed. In some embodiments, users may be limited to accessing only a subset of investing authorities where the subset is based on a total value of the investing authority, investing authorities who have invested in a particular group of stocks, investing authorities of a particular geographic region, and the like. For example, in some example embodiments, the number and/or characteristics (e.g., net worth) of each investing authority made available may be based upon a subscription and/or membership.

By enabling the user to view multiple categories of recognized investing authorities on a single screen, UI 300 facilitates more effective training and quicker selection of investment choices. More effective training is facilitated because the user is allowed to view all the different types of recognized investing authorities available to him/her on a single UI or screen. The scrollability of each list, having an easily recognizable image associated with each investing authority, and having all (or many) investing authority choices arranged on a single screen help in making the selection process more user friendly to even users who have little or no prior investment experience.

The UI 300 may be used to provide further guidance to the user by leveraging on it displaying multiple types of investing authorities in a single screen. For example, when a user selects a first billionaire, the other investing authorities (e.g., one or more asset managers, one or more pension funds etc.) in which that billionaire has invested may be highlighted for easier examination by the user. Similarly, when a user selects a billionaire, one or more other billionaires or other investing authorities who have a similar investing style (e.g., one or more of similar pattern of investing, similar investment choices, similar total amount of wealth invested, and the like) to the selected billionaire can be highlighted (or rearranged to be closer to the selected billionaire in the list layout) so that user is further assisted in making an informed selection.

The above description indicated several example techniques by which the UI 300 layout of multiple scrollable lists of different types of investing authorities to facilitate the user's selection in a more informed and efficient manner. However, other techniques of associating respective investing authorities in the UI in order to further facilitate user selection may be exercised while being consistent with the teachings in this disclosure.

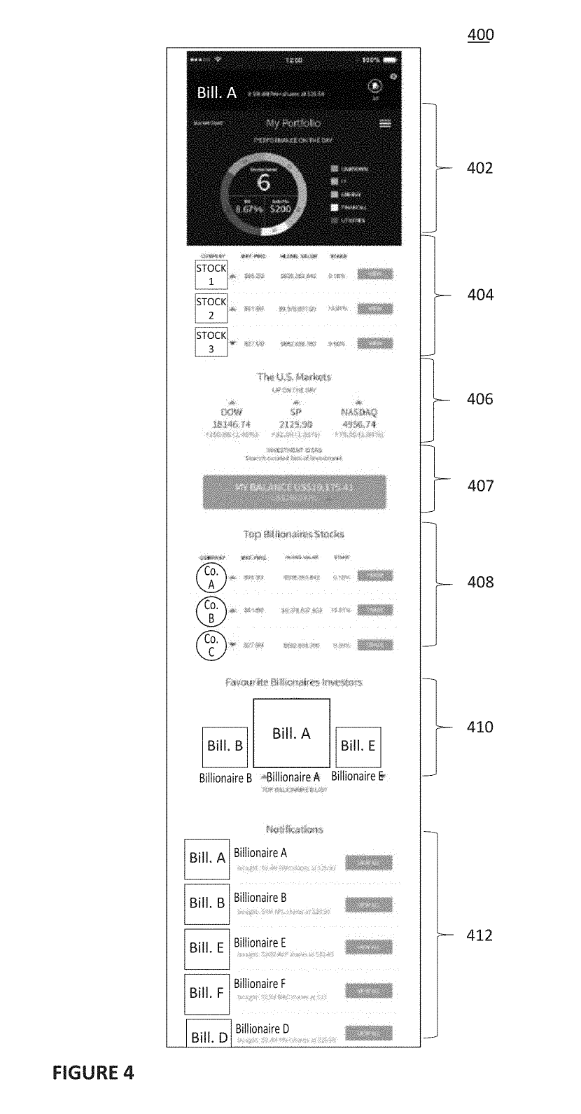

FIG. 4 illustrates a UI 400 that provides the logged in user with an overview of the user's portfolio and a drill-down into a selected billionaire, according to some example embodiments. Portions 402-404 display an overview of the user's portfolio (see 402) and a portion of the investments from the user's portfolio (see 404). The overview of the user's portfolio may include a graphical representation that indicates the relative proportion of ownership of investment instruments in the various investment sectors (e.g., IT, Energy, Financial, Utilities), the number of investment instruments (e.g., number of stock) owned, return on investment and a gain in dollar terms. The overview may be based on the day's performance or some other evaluation period. In another portion 404 of UI 400, a configured number of investments owned by the user may be displayed. The list may be scrollable. For each investment, certain selected and/or configurable set of data points may be displayed. For example, as shown in FIG. 4, for each investment shown in portion 404, a symbol, an indication whether the investment has gained or lost in the current time period, market price of the investment, the value of the user's holding in each investment, and the stake as a percentage of the user's portfolio may be represented.

General market information, such as the performance of various indexes (e.g., DOW™, S&P™, NASDAQ™ etc.) may be displayed in an area 406 of UI 400.

Area 407 may be used to display the total balances in investments and in available virtual money and/or cash. The user portfolio balance represents the virtual money to practice investing amongst the investing authorities and is a true reflection of the value of the user's current investment selections based on real-time US market data.

An area 408 may display a selection of investments from the currently selected investment authority. In FIG. 4, area 408 displays investments selected from the representative portfolio constructed from obtained information regarding the investments of the currently selected billionaire. The investments selected for display in area 408 may be the set of investments that best matches the user's investments. In some example embodiments, area 408 the displayed investments may include one or more of the selected investment authority's most recent trades, the selected investment authority's investments which have the largest changes during the evaluation period, and/or the selected investment authority's investments that most closely matches (e.g., identical or in similar industry).

An area 410 of UI 400 may be used to highlight the currently selected investing authority or authorities. In some embodiments, the selected one or more investing authorities are displayed in relation to one or more other investing authorities. The displayed investing authorities may be arranged so that proximity represents the similarity level in the respective representative portfolio of each displayed investing authority. For example, in the illustrated area 410 shown in FIG. 4, the investing authorities to the left and right of the selected investing authority may have been selected for display because their respective representative portfolios are most closely matched to the representative portfolio of the selected investing authority. Area 410 may also indicate, with respect to each investing authority displayed, whether the associated representative portfolio has gained or lost in the current evaluation period.

In some embodiments, area 410 displays one or more selected investing authorities that the user has selected as ‘favorites’. In such embodiments, the investment instruments displayed in area 408 may be a selected number of the investment instruments that are determined to be most popular among all the favorite investing authorities. Being able to quickly see the most popular investments among all investing authorities may give the user a sense of confidence about which company is more likely to perform and to focus on investing. Moreover, in such embodiments, the notifications displayed on area 412 (see below) may be filtered to display only notifications pertaining to favorite investing authorities. The selection of an investing authority as a favorite may, at least in some embodiments, trigger notification activity alerts in real time when that investing authority is featured in the media such that a push message may notify user in app or display on home screen.

Another area 412 on UI 400 may display notifications of pertinent current information regarding one or more investing authorities. For example, as illustrated in FIG. 4, area 412 may display the last trade done by each investing authority in the evaluation period. With respect to each transaction, the investment instruments symbol, price, amount of investment units, value of the transaction, etc. may be displayed. In some example embodiments, the displaying of users' portfolios similar to billionaires and commonly traded investment instruments may use a ranking system based upon characteristics such as asset class, stocks and purchase price.

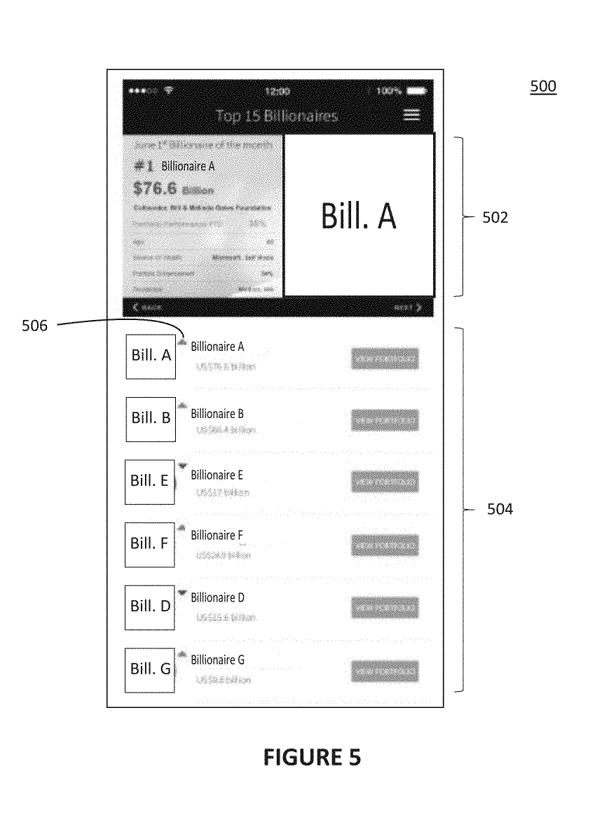

FIG. 5 illustrates a UI 500 showing the selected investing authority, according to some example embodiments. In UI 500, an area 502 displays the investing authority (in the illustrated instance, a billionaire) who has the best performance for the evaluation period. Another area 504 displays the list of the selected investing authority, where some information such as, for example, the current value of the representative portfolio for each investing authority and an indication whether the representative portfolio gained or lost for the evaluation period, etc., may be displayed for each selected investing authority. UI 500 screen and functionality allows the user to view a list of a predetermined number of investing authorities by ranking and source of wealth, by net worth, by performance year to date, and/or by individual personal information. From UI 500, the user can either view the next investing authority in line or select view portfolio to go into individual holdings of the currently viewed investing authority.

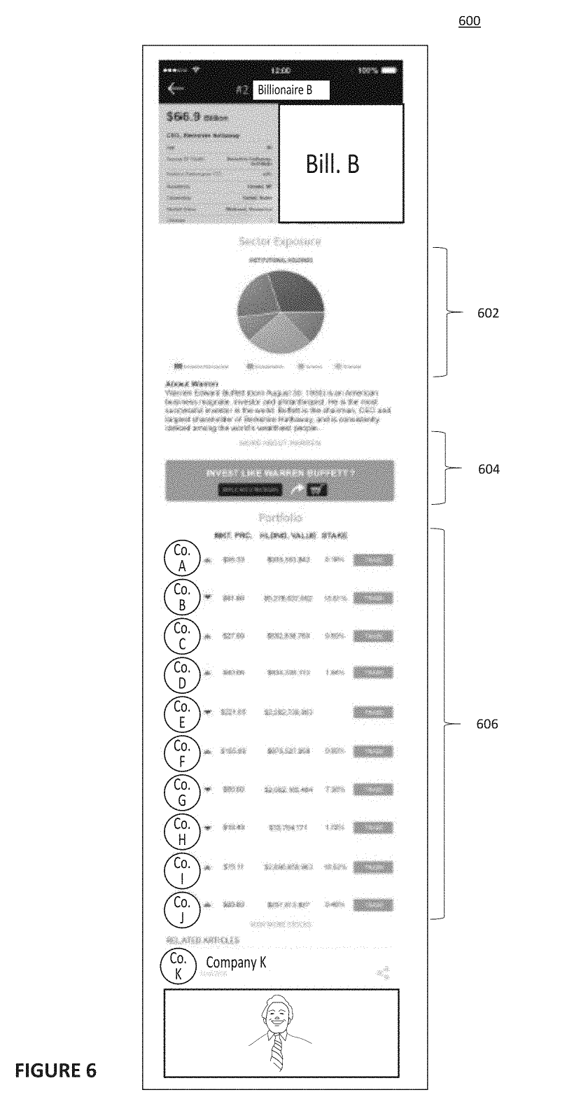

FIG. 6 illustrates a UI 600 showing a selected investing authority's information, according to some example embodiments. This screen and functionality display the investing authority's content with options to select as “favorite” or to compare. A pie chart 602 below may showcase the sectors each investing authority invests in, percentage of portfolio exposed within this sector, and amount of money invested in the sector.

The user has the option, in an area 604, to touch (r click on) a checkout cart or replicate strategies and the application will emulate his/her top investment instrument holdings 606. The company, market price, percent of portfolio or can trade those same investment instruments individually. Additionally, a financial information news feed may auto populate real time news about the investing authority that the user is currently viewing in order to update the user.

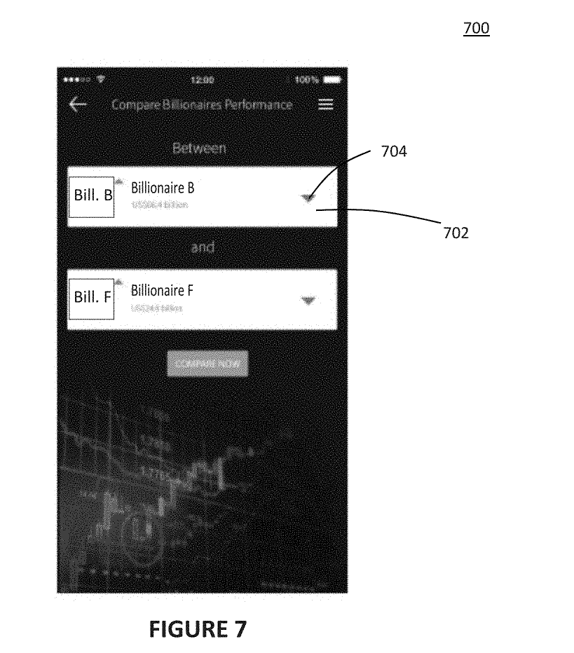

FIG. 7 illustrates a UI 700 for enabling the logged in user to compare a plurality of investment authorities, according to some example embodiments. Multiple investment authorities 702 can be selected for comparison with each other. Configuration item 704, within each panel 702, enables the user to cycle through a list of investment authorities. The UI 700 enables the user to quickly change selections etc., and thereby analyze different scenarios.

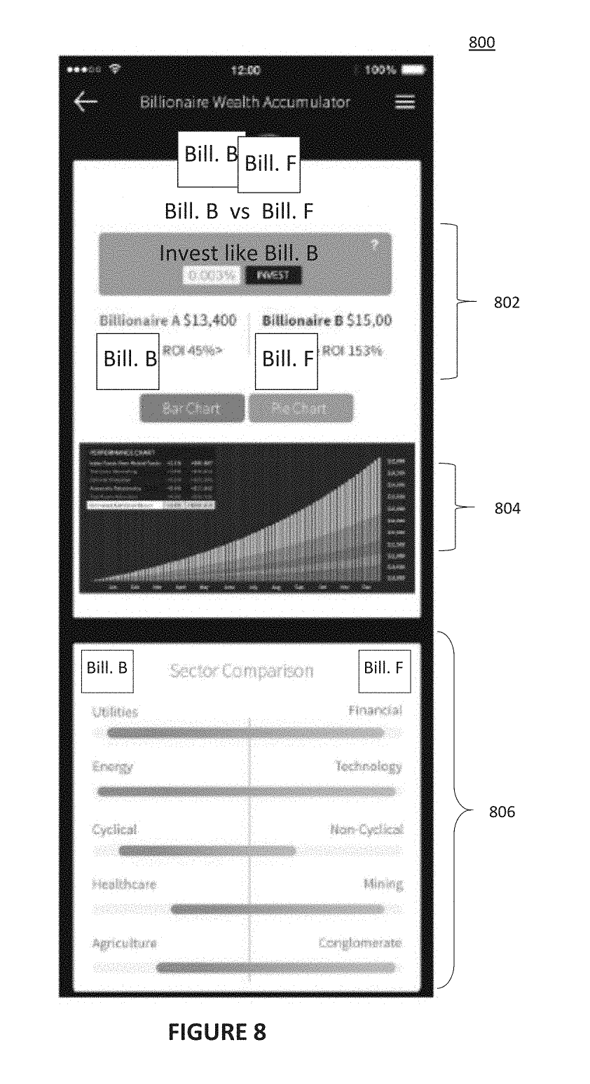

FIG. 8 illustrates a displayed output 800 of a comparison, according to some example embodiments. Once compared the portal transforms into a predictive module which highlights future value of what the current value of the user's portfolio (e.g., $10,000) could be worth and which investing authority portfolio is likely to have the most return. This may be automatically calculated through predetermined algorithms using individual rankings and data points for future value of the investment instruments held in the investing authority portfolio, then an average percentage may be generated. Also, this UI may be used to compare a predetermined number of sectors invested in by each investing authority making it transparent for the user to replicate their portfolio here.

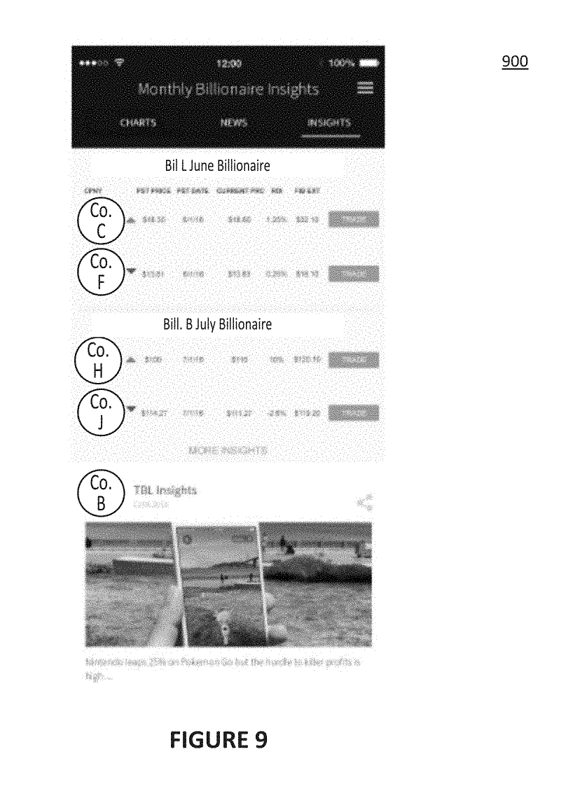

FIG. 9 illustrates a displayed output 900 of a regular summary insight provided by the trading/training tool. The summary insight is developed using certain algorithms and Fibonacci ratio computations to automatically identify a predetermined number (e.g., two) best performing investment instruments in each investing authority's representative portfolio. Every month, for example, the trading training application may automatically select a random investing authority and then display the company, posted price, posted date, current price, projected return on investment (ROI), and Fibonacci Extension levels as to where the stock will go into the future. The user may be provided with the option to trade these posting directly from screen in any for any featured investing authority and may also be enabled to share the trade via social media.

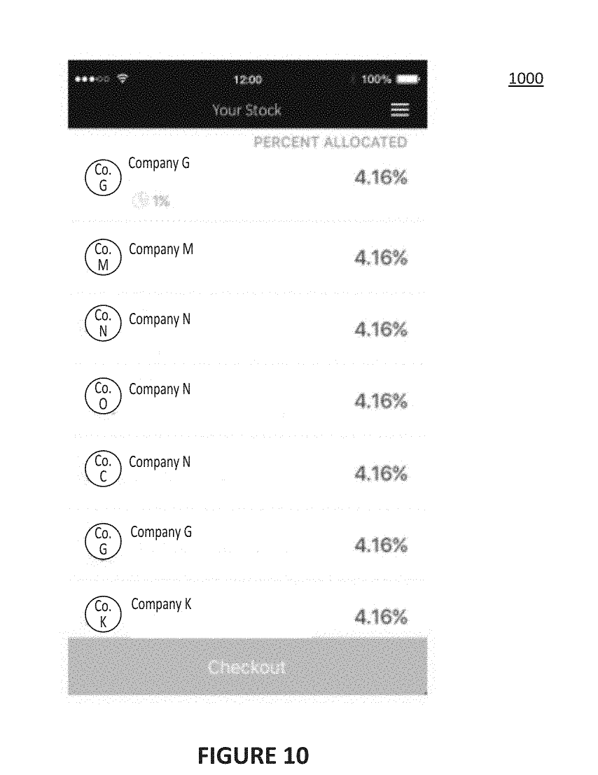

FIG. 10 shows a UI that allows the user to emulate a selected investment authority's stock portfolio in real time via click of a button. Additionally, a percentage allocated is calculated based on each investing authority's stake in their top predetermined number of holdings (according to the representative portfolio for that investing authority) which gives the user identical portfolio exposure within those same companies. To illustrate, consider an example where a user has $10,000 in her account. When the user selects to replicate a specified percentage of her portfolio in accordance with a selected investing authority, the selection may be as follows based on the investing authority's top predetermined number (e.g., eleven) of investment instruments: Berkshire™ at 65% of portfolio; Caterpillar™ at 10% of portfolio; IBM™ at 2% of portfolio; and Facebook™ at 2% of portfolio. Additionally, the user may be enabled to select if she wants to invest all her balance, or only a part of the balance in a dollar amount such as $2,000 to replicate the investing authority out of the available balance of $10,000, and still have a balance of $8,000 to replicate other investing authorities' portfolio strategies.

Some example embodiments may also enable a user, upon selecting to trade a particular investment instrument or in accordance with a particular investing authority, to invite a friend to do the same via a social media channel. Some example embodiments may provide for selecting one or more other users of the trading training application as “buddies” that communicate with the user via a social media chat channel or the like, where the buddies are selected (and proposed to the user for selection) in accordance with the investing authorities selected in common between the respective buddies and the user. Users may also be provided with the capability to follow one or more other user's performance in real-time, and to interact with other users. Some example embodiments may provide some users with access to an artificial intelligence enabled analytics process that provides financial instrument related information in real time.

Example embodiments, in contrast to conventional tools, provide for displaying a configurable number of top stocks or other investment instruments in which one or more investment authorities have invested in, the sectors they have invest in and the amount of money invested in each, the portion of portfolio exposure and market value, and price in real time so users can substantially replicate their strategy with fractional shares that allows them to invest in smaller amounts but own the same or similar mix of investment using similar methodologies employed by the investing authorities from a click of a button in a mobile application with virtual and/or real money.

In contrast to conventional tools, the trading/training tool enables a simple process via mobile (or other) application to replicate a representative portfolio of an investing authority via dollar based investing of virtual and/or real money to own fractional shares with just a few clicks of a button.

The tool, according to some embodiments, enables the selection of favorite investing authorities by each user. The user may then be more selectively provided with recommendations of recent transactions placed by these investing authorities.

The tool, according to some embodiments, may also provide a predictive module that can be accessed from a tap of a button within the application so that users can have a clear view on what their portfolio would be worth using price model projections integration and automation driven by artificial intelligence.

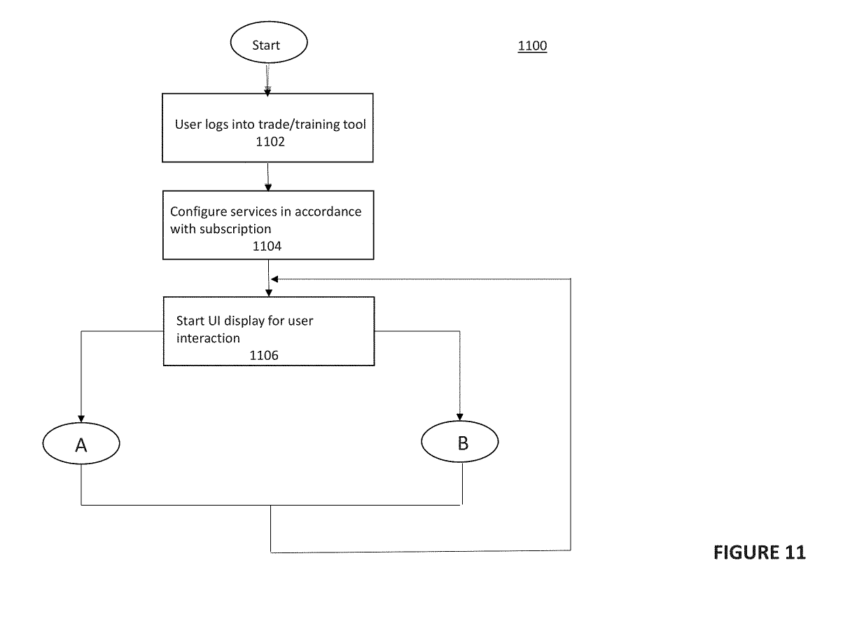

FIG. 11 illustrates a flowchart for a process 1100 implemented in an investment training tool according to some example embodiments. Process 1100 may be executed, for example, in the trading/training tool 104 when a user logs in via a client device such as client device 108 or 110.

After the process 1100 is entered, at operation 1102, the user navigates to a website provided by (e.g., hosted on) server 102 and trading/training tool 104, and logs in. Upon a user logging in, the trading/training tool may retrieve a profile of the user and/or configurations associated with the user.

At operation 1104, one or more services provided by trading/training tool 104 may be configured in accordance with a user's subscription level or configuration. User subscription information may be stored in a data storage such as data storage 106 in the user's profile and/or configurations. Services configured according to subscription level may include, for example, the real-time investment information service, the real-time stock price provider, the electronic trading platform, the amount of virtual funds available to the user, whether the user is permitted to engage in actual trading via the trading/training tool (and using real money from a bank account or the like), the selection of investment options available to the user, such as, e.g., which types of investing authorities (e.g., billionaires, asset managers, and/or pension funds) are available for selection by the user, which specific individual options (e.g., which billionaires, which asset managers, and/or which pension funds) from an investing authority are available to the user, which investment instruments are available to the user, what portion of an investing authority's portfolio is available for the user to replicate, whether the user's portfolio is controllable on an ongoing-basis in accordance with the investing authority's portfolio, whether the user can personalize triggers associated with the control according to investing authority portfolios, etc.

At operation 1106, a UI is displayed. In some example embodiments, a UI for selecting investing authorities, such as the UI shown in FIG. 3 may be displayed. In some example embodiments, the initial UI may display the user's current portfolio information, such as, for example, the UI shown in FIG. 4. One or more different UI may be invoked in this operation. For example, operation 1106, may include displaying and obtaining user input on one or more UI such as the UIs shown in FIGS. 5-6 which enable the user to perform research regarding selected investing authorities and/or individual or grouped investments.

At operation 1106, the user may also select among options including reconfiguring the user's portfolio, performing research, performing an actual trade in an electronic trading platform, configuring settings, etc.

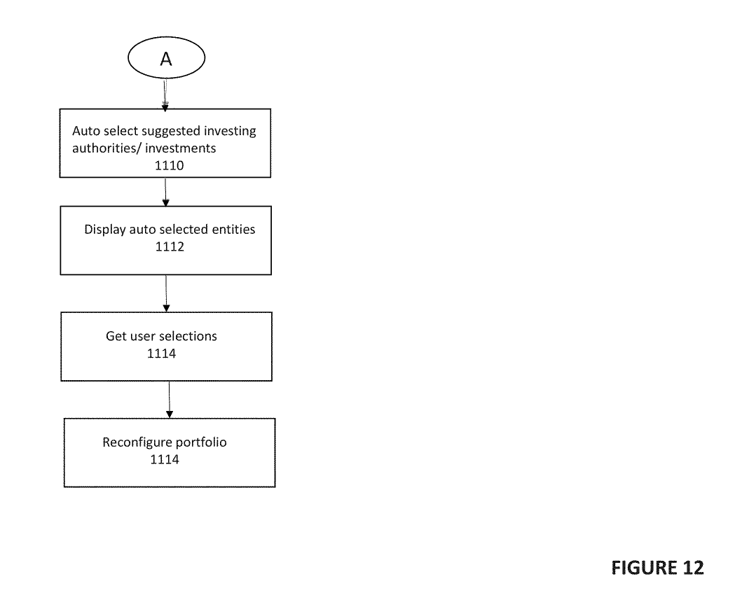

If the user chooses to reconfigure the portfolio (e.g., by buying/selling one or more investment items), at operation 1110 (shown in FIG. 12), the system automatically selects suggested investing authorities and/or investment items for presenting to the user. As also described above, the user may be presented with all the available investing authorities and/or all the available investment items. In some example embodiments, the investing authorities and/or the investment items presented to the user may be restricted based upon any of configuration, subscription, current performance of the user, etc. Restricting based upon configuration and subscription were described above. Current performance can also be used as a criteria for restricting, for example, by filtering the investing authorities in respectively different manners. For example, depending on the user's current portfolio value and/or the success level (e.g., increase/decrease in portfolio value over evaluation period), different sets (e.g., sets of investing authorities filtered based on current value of their respective portfolios) of the investing authorities may be made available to the user for selection.

At operation 1112, display the automatically selected investments and/or investment options to the user, so that user selections can be made. For example, the display may be a UI such as that shown in FIG. 3, with each scrollable list of investing authorities including investing authorities selected in operation 1110. As shown in FIG. 3 more than one type of investing authorities may be shown arranged in respective scrollable lists on the same screen, in order to facilitate informed user selection.

At operation 1114, the user selection(s) are obtained. The user, via the client-side portion 105, selects at least one of the investing authorities (e.g., by mouse click, touch etc.).

At operation 1116, the portfolio is reconfigured in accordance with the user's selection of one or more investing authorities. According to some example embodiments, the user selects one investing authority, say “Billionaire A”, and, possibly after reviewing the representative portfolio of that investing authority, elects to make one or more trades that are fashioned in accordance with that investing authority's latest transactions, or to reconfigure a portion of the user's portfolio in the manner of that investing authority's representative portfolio.

The user may elect to make one or more trades that are fashioned in accordance with that investing authority's latest transactions by first displaying the latest transactions made by that investing authority and selecting all or a plurality of those transactions to be replicated and executed in the user's own portfolio.

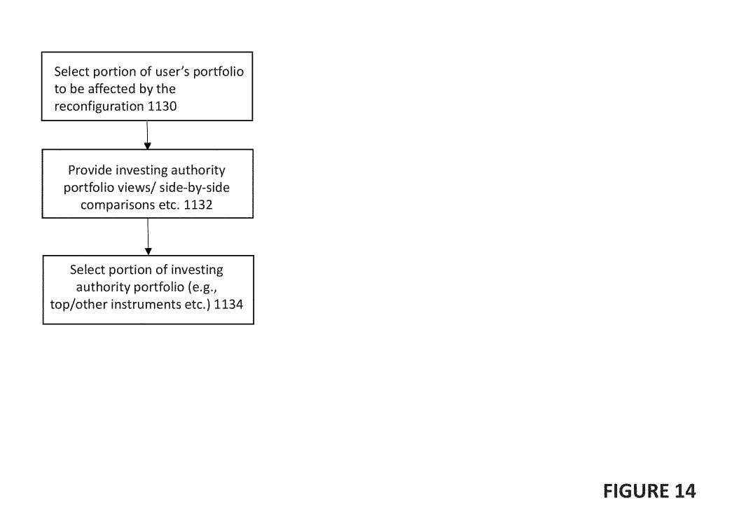

The user may elect to reconfigure a portion of the user's portfolio in the manner of that investing authority's representative portfolio by selecting to replicate all or a portion of the user's portfolio in accordance with the selected investing authority's portfolio. The user may indicate a portion of the user's portfolio that is desired to be replicated in the manner of the investing authority. The portion may be indicated as a percentage or a monetary amount (e.g., a dollar amount that is less than the user's current portfolio value). In some embodiments, the user may select the portion to be affected as a selection of investment instruments already in his/her portfolio. Operation 1130 shown in FIG. 14, illustrates selecting a portion of the user's portfolio to be affected by the reconfiguration. By default the trading/training tool may be configured to replicate the entire portfolio of the user when a portion less than the whole is not specified by the user.

Upon determining that the user has selected to replicate all or a portion of the user's portfolio in accordance with a selected investing authority, the trading/training tool proceeds to construct one or more transactions to arrive at the goal of having the user's portfolio replicated in accordance with the selected investing authority's portfolio. This may include the user using the training tool to investigate and/or compare various investing authorities and/or individual investment instruments. In some embodiments, the user may use display screens such as that shown in FIGS. 6-9 to assist in this selection. Operation 1132 shown in FIG. 14 provides investing authority portfolio views/side-by-side comparisons etc. After the comparison etc., the user may select a portion of an investing authority's portfolio, as shown in operation 1134 of FIG. 14, to replicate and/or otherwise base a subsequent trade. The portion may be selected as a predetermined number of the authority's highest performing investment instruments (e.g., top 11 stocks, largest stock holdings which generate a predetermined percentage of an increase in portfolio value). In some example embodiments, the user merely selects a “checkout” option, for example, by selecting a “checkout cart” displayed in association with the selected investing authority (e.g., an example checkout cart is shown in the area 604 in FIG. 6). The trading application may automatically generate a sequence of one or more trade transactions to achieve the user's selection. For example, such as sequence may include selling one or more investment instruments currently in the user's portfolio, and buying one or more investment instruments that are identified in the selected portion of the authority's portfolio. Subsequently the constructed one or more transactions are executed, and the resulting portfolio is displayed on a UI on the client device.

An aspect of the capabilities provided to the user by the trading training application may be referred to as “seamless investing”. In seamless investing, the trading/training tool 104 utilizes third party data, such as, but not limited to, information about the representative portfolios of selected investing authorities, and certain customized algorithms to achieve a fractional trading outcome, thereby achieving a model including substantially replicating stock trades done by the investing authorities such as billionaires, investment banks and pension funds. Users of the trading/training tool can engage in seamless investing, which is at their fingertips by launching the trading/training tool on a smartphone or other computing device, to perform real time trading using software-driven portfolio replication techniques etc.

After operation 1116 (operations 1110-1116 are shown in FIG. 12), process 1100 proceeds to operation 1106, where the user's portfolio is displayed in accordance with the reconfigured selection of investments, and from where the user may proceed to perform further research and/or reconfiguration of the user's portfolio.

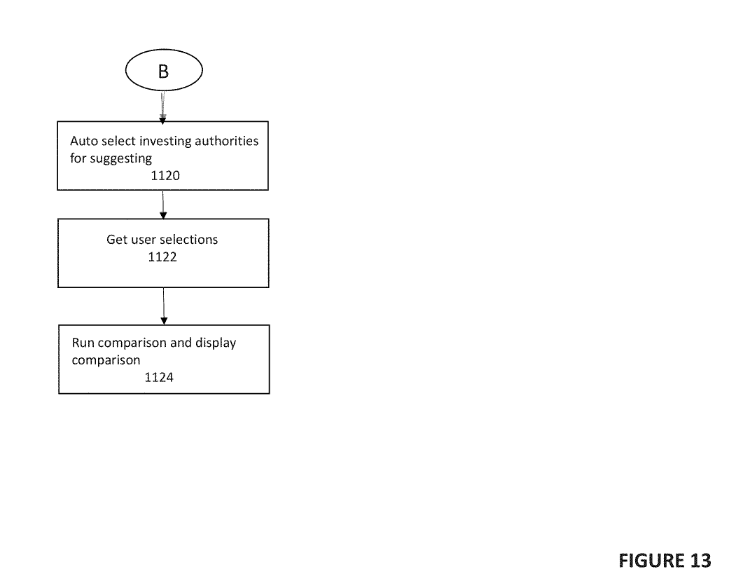

If, at operation 1106, the user elected to perform research and/or comparison of investments/investment options, process 1100 proceeds to operation 1120 (shown in FIG. 13). At operation 1120, one or more investments or investing authorities are automatically selected for proposing to the user. According to some example embodiments, the automatic selection may be performed in a manner similar to that described above in relation to operation 1110.

At operation 1122, the user selection is obtained for two or more investing authorities to be researched and/or compared. According to some example embodiments, the user selections may each be obtained in a manner similar to that described in relation to operation 1112. FIG. 7 illustrates an example UI display where the user has chosen two investing authorities to be compared. The information which is compared may include information such as the investment instrument mix in the portfolio etc., as well as sector-by-sector comparison of selected investing authorities.

At operation 1124, if the user had elected to perform research on a particular investing authority, a UI displaying portfolio information for that investing authority may be displayed. If the user had selected to perform a compare, then the compare is performed in accordance with the user selection. FIG. 8 illustrates an example UI displaying the output of a compare.

After operation 1124 (operations 1120-1124 are shown in FIG. 13), the process 1100 may proceed to operation 1106 and await further input from the user to, for example, perform further trading, research or other tasks, or to exit the trading training application.

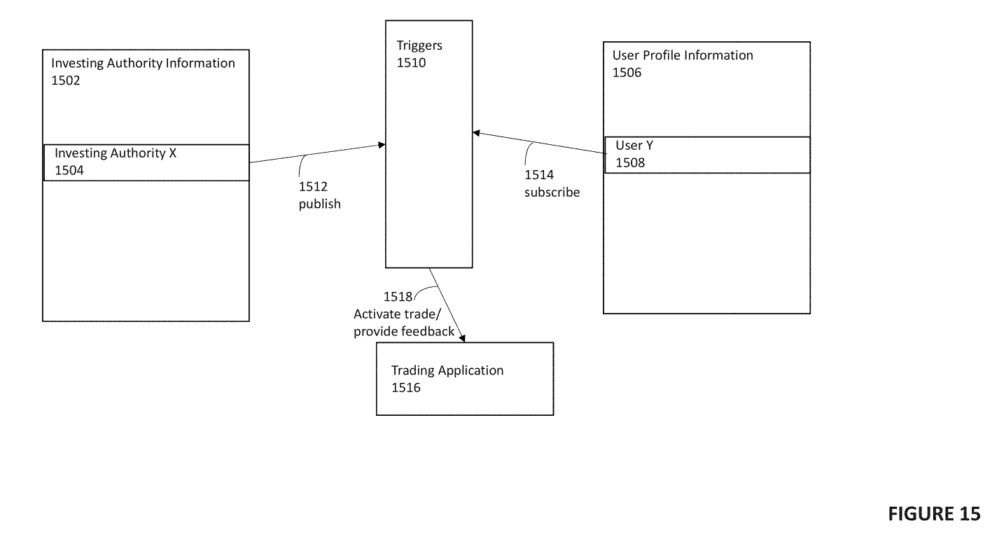

FIG. 15 illustrates a trigger framework that may be used in some embodiments to facilitate the maintaining of a user's investment portfolio in accordance with the portfolios of one or more investment authorities. As shown in FIG. 15, the trading application 1516 may subscribe respective investing authorities to a publish-subscribe framework for triggers 1510. For example, respective records (e.g. an individual record representing a calculated profile for investing authority X 1504) in a store of investing authority profiles 1502 may publish events 1512 to the trigger framework 1510. Also, respective records (e.g., individual record representing a user Y's profile 1508) in a user profile information store 1506 may subscribe 1514 to the trigger framework. The trigger framework will enable a user to either receive all updates from authorities to which the user subscribed or to customize such updates. For example, whereas an authority may publish all its trade transactions, a certain user may choose to filter out all transactions below a certain threshold value. In some embodiments, a periodic monitoring task (not separately shown in FIG. 15), which may automatically be run at predetermined intervals and/or upon completion of a transaction that is above a predetermined value by an investing authority, may monitor for substantial changes in an investing authority's portfolio. For example, the monitoring task may compare a copy of a portfolio of a particular investing authority taken at an earlier time, with a current view of that particular investing authority's portfolio. A substantial change may be detected as a change in value exceeding a predetermined gain or loss value, or as a change exceeding a predetermined threshold number in the composition of investment instruments in the portfolio. Upon detection of such a monitored for event, the relevant information may be published to the trigger framework which can then trigger automatic transactions for subscribed users in order to keep those user's portfolios in synchronization with the selected investing authorities. Such information may also be provided as feedback and/or trade information 1518 to the trade application 1516. In some embodiments, the controlling of the user's portfolio based on a selected one or more investing authority portfolio's may be based on user approval of each synchronization of the user's portfolio, or in some other embodiments, may be automatically carried out within parameters (e.g., total change in value being less than a configured threshold, total number of changes in investment items being below a threshold, etc.) configured by the user.

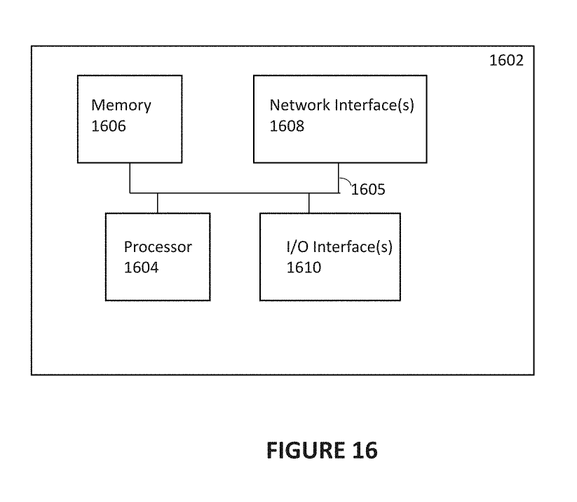

FIG. 16 is a block diagram of a processing system, computer or computing device 1602 that may be included in any of server 102, external servers 112-116 and/or client devices 108-110, shown in FIG. 1. According to some embodiments, the computer 1602 may execute the trading/training tool 104, the client-side portion 105 of the trade training tool 104, and data storage 106. For example, the computer 1602 may perform the processes described in relation to FIGS. 11-15, and generate and display the user interfaces shown in FIGS. 3-10. The computer 1602 may comprise a processor 1604, a communicating infrastructure 1605 connecting the components of the computer, a memory 1606, a network interface 1608, and I/O interfaces 1610.

Processor 1604 may include one processor or more than one interconnected processors. The memory 1606 may be configured to efficiently store temporary associations between social media content records and emotion categories during execution of processes.

Network interface(s) 1608 are utilized by processor 1602 to access other computers and/or receiving messages from other computers. I/O interface(s) 1610 enables users to interact with the computer 1602 and/or provide configuration information and control information via one or more of a keyboard, touchscreen, voice to text translation etc. I/O interface 1610 also enables delivery of the results of the processing performed by the processor to a screen or display. For example, an example screen that may display results of the process performed is shown in FIG. 3.

In the examples described herein, for purposes of explanation and non-limitation, specific details are set forth, such as particular nodes, functional entities, techniques, protocols, standards, etc. in order to provide an understanding of the described technology. It will be apparent to one skilled in the art that other embodiments may be practiced apart from the specific details described below. In other instances, detailed descriptions of well-known methods, devices, techniques, etc. are omitted so as not to obscure the description with unnecessary detail. Individual function blocks are shown in the figures. Those skilled in the art will appreciate that the functions of those blocks may be implemented using individual hardware circuits, using software programs and data in conjunction with a suitably programmed microprocessor or general purpose computer, using applications specific integrated circuitry (ASIC), and/or using one or more digital signal processors (DSPs). The software program instructions and data may be stored on computer-readable storage medium and when the instructions are executed by a computer or other suitable processor control, the computer or processor performs the functions. Although databases may be depicted herein as tables, other formats (including relational databases, object-based models, and/or distributed databases) may be used to store and manipulate data.

Processors, memory, network interfaces, I/O interfaces, and displays noted above are, or includes, hardware devices (for example, electronic circuits or combinations of circuits) that are configured to perform various different functions for a computing device, such as computer 1602.

In some embodiments, each or any of the processors 1604 is or includes, for example, a single- or multi-core processor, a microprocessor (e.g., which may be referred to as a central processing unit or CPU), a digital signal processor (DSP), a microprocessor in association with a DSP core, an Application Specific Integrated Circuit (ASIC), a Field Programmable Gate Array (FPGA) circuit, or a system-on-a-chip (SOC) (e.g., an integrated circuit that includes a CPU and other hardware components such as memory, networking interfaces, and the like). And/or, in some embodiments, each or any of the processors 1602 uses an instruction set architecture such as x86 or Advanced RISC Machine (ARM).

In some embodiments, each or any of the memory devices 106 is or includes a random access memory (RAM) (such as a Dynamic RAM (DRAM) or Static RAM (SRAM)), a flash memory (based on, e.g., NAND or NOR technology), a hard disk, a magneto-optical medium, an optical medium, cache memory, a register (e.g., that holds instructions), or other type of device that performs the volatile or non-volatile storage of data and/or instructions (e.g., software that is executed on or by processors 1602). Memory devices 1604 are examples of non-volatile computer-readable storage media.

In some embodiments, each or any of the network interface devices 1608 includes one or more circuits (such as a baseband processor and/or a wired or wireless transceiver), and implements layer one, layer two, and/or higher layers for one or more wired communications technologies (such as Ethernet (IEEE 802.3) and/or wireless communications technologies (such as Bluetooth, WiFi (IEEE 802.11), GSM, CDMA2000, UMTS, LTE, LTE-Advanced (LTE-A), and/or other short-range, mid-range, and/or long-range wireless communications technologies). Transceivers may comprise circuitry for a transmitter and a receiver. The transmitter and receiver may share a common housing and may share some or all of the circuitry in the housing to perform transmission and reception. In some embodiments, the transmitter and receiver of a transceiver may not share any common circuitry and/or may be in the same or separate housings.

In some embodiments, each or any of the display interfaces in I/O interfaces 1610 is or includes one or more circuits that receive data from the processors 104, generate (e.g., via a discrete GPU, an integrated GPU, a CPU executing graphical processing, or the like) corresponding image data based on the received data, and/or output (e.g., a High-Definition Multimedia Interface (HDMI), a DisplayPort Interface, a Video Graphics Array (VGA) interface, a Digital Video Interface (DVI), or the like), the generated image data to the display device, which displays the image data. Alternatively or additionally, in some embodiments, each or any of the display interfaces is or includes, for example, a video card, video adapter, or graphics processing unit (GPU).

In some embodiments, each or any of the user input adapters in I/O interfaces 1610 is or includes one or more circuits that receive and process user input data from one or more user input devices that are included in, attached to, or otherwise in communication with the computing device 1602, and that output data based on the received input data to the processors 1604. Alternatively or additionally, in some embodiments each or any of the user input adapters is or includes, for example, a PS/2 interface, a USB interface, a touchscreen controller, or the like; and/or the user input adapters facilitates input from user input devices such as, for example, a keyboard, mouse, trackpad, touchscreen, etc.

Various forms of computer readable media/transmissions may be involved in carrying data (e.g., sequences of instructions) to a processor. For example, data may be (i) delivered from a memory to a processor; (ii) carried over any type of transmission medium (e.g., wire, wireless, optical, etc.); (iii) formatted and/or transmitted according to numerous formats, standards or protocols, such as Ethernet (or IEEE 802.3), ATP, Bluetooth, and TCP/IP, TDMA, CDMA, 3G, etc.; and/or (iv) encrypted to ensure privacy or prevent fraud in any of a variety of ways well known in the art.

It will be appreciated that as used herein, the terms system, subsystem, service, programmed logic circuitry, and the like may be implemented as any suitable combination of software, hardware, firmware, and/or the like. It also will be appreciated that the storage locations herein may be any suitable combination of disk drive devices, memory locations, solid state drives, CD-ROMs, DVDs, tape backups, storage area network (SAN) systems, and/or any other appropriate tangible computer readable storage medium. It also will be appreciated that the techniques described herein may be accomplished by having a processor execute instructions that may be tangibly stored on a computer readable storage medium.

As used herein, the term “non-transitory computer-readable storage medium” includes a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVD, or Blu-Ray Disc, or other type of device for non-transitory electronic data storage. The term “non-transitory computer-readable storage medium” does not include a transitory, propagating electromagnetic signal.

The trading and/or training tool for investment instruments as described in this disclosure advantageously enables even users with no investment experience to participate in trading investment instruments. This improved capability is mainly generated by enabling a user to efficiently harness the massive amount of detailed information regarding the investment practices of experienced and successful investors in order to quickly generate a technique for investing. Example embodiments enable a user to, using very few input actions, generate an investment portfolio that may be similar in aspects to the portfolios of one or more recognized investing authorities. Example embodiments provide a series of display screens and the like that assists the user to quickly compare investing authorities and/or investment instruments and to select his/her own choices. Moreover, the user is enabled to substantially replicate, sometimes in a fractional manner, portfolios that are recognized as being successful with the use of just one click or very few user input actions. The user is also enables to, upon configuration, automatically control his/her own portfolio in accordance with a selected one or more investment authority portfolios.

When it is described in this document that an action “may,” “can,” or “could” be performed, that a feature or component “may,” “can,” or “could” be included in or is applicable to a given context, that a given item “may,” “can,” or “could” possess a given attribute, or whenever any similar phrase involving the term “may,” “can,” or “could” is used, it should be understood that the given action, feature, component, attribute, etc. is present in at least one embodiment, though is not necessarily present in all embodiments.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the technology, and does not imply that the illustrated process is preferred.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A training tool for training a user to trade investment items in an electronic trading system, comprising:
a memory;
a network communication interface; and
a processor configured to, in conjunction with the memory and the network communication interface, perform operations comprising:
identifying at least one selected investing authority;
identifying a plurality of investment instruments that are already in a representative portfolio associated with the identified at least one selected investing authority;
determining, based upon the identified plurality of investment instruments already in the representative portfolio, a proposed trade for the user, wherein the proposed trade includes the identified plurality of investment instruments in relative proportions corresponding to that in the representative portfolio; and
using real time price information, executing the proposed trade with at least virtual money amounts in an account of the user such that a portfolio of the user is reconfigured.

2. The training tool according to claim 1, wherein the processor is further configured to:
upon completion of the executing the proposed trade, reconfigure the portfolio of the user to represent a change effected by the executing, wherein the change is in a quantity or type of an investment instrument and an amount of virtual money or money in the account.

3. The training tool according to claim 1, wherein the processor is further configured to:
receive user input identifying an investing authority, wherein the identifying at least one selected investing authority is performed based on the user identified investing authority; and
automatically perform said identifying a plurality of investment instruments and said determining a proposed trade without further user input.

4. The training tool according to claim 1, wherein the processor is further configured to:
automatically perform the identifying at least one selected investing authority, said identifying a plurality of investment instruments, and said determining a proposed trade without further user input.

5. The training tool according to claim 1, wherein the processor is further configured to:
access information regarding a plurality of investing authorities from each of two or more investing authority categories; and
display two or more investing authorities from each of the categories such that user input is enabled to select any of the displayed investing authorities as the selecting investing authority.

6. The training tool according to claim 5, wherein the processor is further configured to:
select the two or more investing authorities from each of the categories based on that user's subscription level, wherein the training tool is configured to limit access to respective subsets of the plurality of investing authorities in accordance with subscription levels.

7. The training tool according to claim 6, wherein the processor is further configured to:
perform said limiting access based on any of an investment instrument in a portfolio of an investing authority, a current value of a portfolio of an investing authority, a popularity of an investing authority, and a performance of an investing authority.

8. The training tool according to claim 1, wherein said identifying a plurality of investment instruments comprises automatically detecting a predetermined number of highest performing instruments in the representative portfolio.

9. The training tool according to claim 1, wherein said identifying a plurality of investment instruments comprises automatically detecting a predetermined number of instruments in the representative portfolio in accordance with a predetermined criteria associated with a subscription level of the user.

10. The training tool according to claim 9, wherein said determining a proposed trade for the user comprises:
detecting relative proportions of the plurality of investment instruments already in the representative portfolio;
detecting a total value of the plurality of investment instruments already in the representative portfolio;
detecting a trade value associated with the user's portfolio for use in the proposed trade; and
determining scaled quantities of respective investment instruments corresponding to each of the identified plurality of investment instruments already in the representative portfolio in accordance with a scale of the detected total value of the plurality of investment instruments already in the representative portfolio and the detected trade value.

10. The training tool according to claim 9, wherein said executing the proposed trade comprises executing the proposed trade to arrive, in the portfolio of the user, at the scaled quantities of respective investment instruments corresponding to each of the identified plurality of investment instruments already in the representative portfolio.

11. The training tool according to claim 10, wherein the proposed trade is executed with real money in said account.

12. The training tool according to claim 9, wherein said executing the proposed trade comprises executing the proposed trade to arrive, in a predefined portion of the portfolio of the user, at the scaled quantities of respective investment instruments corresponding to each of the identified plurality of investment instruments already in the representative portfolio.

13. The training tool according to claim 12, wherein the processor is further configured to:
configure one or more triggers to automatically control at least a portion of the portfolio of the user in accordance with the representative portfolio; and
based upon the configured one or more triggers, periodically and automatically controlling at least the portion of the portfolio of the user in accordance with the representative portfolio.

14. The training tool according to claim 13, wherein the controlling comprises changing one or more of a mix of investment instruments or a proportion of investment instruments in the portfolio of the user in accordance with the representative portfolio.

15. The training tool according to claim 13, wherein the triggers are configured in accordance with a publish-subscribe framework.

16. The training tool according to claim 5, wherein the processor is further configured to display a screen including a view of the portfolio of the user, a portfolio of said at least one selected investing authority.

17. The training tool according to claim 16, wherein the processor is further configured to:
display a selectable button in association with the displayed portfolio of the at least one selected investing authority; and
in response to selecting of the button, automatically perform said executing the proposed trade with one or more of the identified plurality of investment instruments being selected from the displayed portfolio of the at least one selected investing authority.

18. The training tool according to claim 16, further comprising displaying notifications of recent activity by the at least one selected investing authority on the same screen.

19. The training tool according to claim 18, further comprising displaying a scrollable list of two or more investing authorities on the same screen, and displaying a portfolio and notifications of an investing authority on the same screen in accordance with a user selection from the scrollable list.

20. The training tool according to claim 19, wherein the processor is further configured for displaying side-by-side comparison of selected investing authorities from the scrollable list on one screen, the side-by-side comparison including a configurable sector-by-sector comparison on the same one screen, and wherein a selectable button is displayed on the same one screen to initiate said executing the proposed trade with the identified plurality of investment instruments selected from the portfolio of the investing authority indicated by the selectable button.

21. A method performed by a processor of an investment training/trading tool, comprising:
identifying at least one selected investing authority;
identifying a plurality of investment instruments that are already in a representative portfolio associated with the identified at least one selected investing authority;
determining, based upon the identified plurality of investment instruments already in the representative portfolio, a proposed trade for the user, wherein the proposed trade includes the identified plurality of investment instruments in relative proportions corresponding to that in the representative portfolio; and
using real time price information, executing the proposed trade with at least virtual money amounts in an account of the user such that a portfolio of the user is reconfigured.

22. A non-transitory computer readable medium storing instructions that, when executed by a processor of a computer configured as an investment training/trading tool, causes the computer to perform operations comprising:
identifying at least one selected investing authority;
identifying a plurality of investment instruments that are already in a representative portfolio associated with the identified at least one selected investing authority;
determining, based upon the identified plurality of investment instruments already in the representative portfolio, a proposed trade for the user, wherein the proposed trade includes the identified plurality of investment instruments in relative proportions corresponding to that in the representative portfolio; and
using real time price information, executing the proposed trade with at least virtual money amounts in an account of the user such that a portfolio of the user is reconfigured.
